(19) United States
(12) Patent Application Publication
(10) Pub. No.: US 2012/0150801 A1
(43) Pub. Date: Jun. 14, 2012

(54) PLATFORM AGNOSTIC FILE ATTRIBUTE SYNCHRONIZATION

(75) Inventors: Siddharth Mantri, Seattle, WA (US); Richard Yiu-Sai Chung, Bothell, WA (US)

(73) Assignee: Microsoft Corporation, Redmond, WA (US)

(21) Appl. No.: 12/963,106

(22) Filed: Dec. 8, 2010

(51) Int. Cl. G06F 17/30

(52) U.S. Cl. 707/626; 707/803; 707/E17.005

(57) ABSTRACT

One or more techniques and/or systems are disclosed for providing platform agnostic synchronization for a custom functionality attribute of a file in a distributed data management system. An application and/or device may create or utilize a custom functionality attribute for a file in the distributed data management system. A custom attribute field, comprising data representative of the custom functionality attribute, can be attached to the file, such as with other metadata for the file. The custom attribute field can be stored with the file in the distributed data management system, and can remain unchanged and be synchronized with the file when the file is touched by a device on the distributed data management system.

### BACKGROUND

A distributed data management system can provide for managing data that may be stored on multiple devices connected in a network. For example, a mesh-type network may use different connection arrangements, such as where respective nodes (e.g., connected devices) are connected directly to each of the other nodes; or, where some nodes are connected to the respective devices, and some of the nodes are connected to merely those other nodes with which they commonly exchange data.

Distributed data management systems can provide for distributing a storage load of the data in the network over the plurality of devices connected to the network. In this way, no one or few machines may be overly burdened with storing and distributing data, and a redundancy may be set up so that data loss is mitigated. Further, a distributed data management system may comprise applications that provide for managing the distributed data, thereby making the distribution of the data transparent to client devices connected to the network, for example.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A file synchronization in a distributed data management system provides for updating of files that may be stored and/or accessed in two or more locations in the network using certain rules. For example, it creates or updates a file in the distributed data management system so the file can be synchronized throughout the network, such as by updating the storage location, and/or other information about the file so that other devices may properly access the file without conflict.

Typically, distributed data management systems comprise a file synchronization application platform that provide applications with an ability to replicate network data across devices of different form factors (e.g., servers, mobile devices, desktop and/or laptop machines, etc.), which may be running different operating system platforms, for example. However, synchronization of file (e.g., document, executable, folder, library, media, etc.) attributes associated with the data across platforms is typically not provided for, where an attribute may comprise how the file is handled in a file system hierarchy (e.g., when displaying files in a user interface). Further, attributes for files are typically limited to pre-defined functionalities, such as “hidden file,” “encrypted,” read-only,” “compressed,” and some others, and newly developed functionalities may not be provided for and/or synchronized.

Accordingly, one or more techniques and/or systems are disclosed that provide for synchronization of attributes associated with the network data across different platforms, and can provide for extending a notion of attributes beyond traditional file system functionalities to allow custom definitions of attributes. For example, a distributed data management system (e.g., a mesh-type network) can provide applications with an ability to custom-define attributes associated with a file by defining a custom functionality attribute property (e.g., as a custom bit-flag). The distributed data management system platform can synchronize this property across devices in a platform agnostic fashion, for example, allowing applications to maintain file attribute consistency transparently. Further, as an example, attributes may represent file system specific behavior and/or network-wide synchronization behavior simultaneously.

In one embodiment of providing platform agnostic synchronization for a custom functionality attribute of a file in a distributed data management system, a custom attribute field can be attached to the file, where the custom attribute field comprises data that represents the custom functionality attribute, such as one created by an application and/or device connected to the network. Further, the custom attribute field is stored with the file in the distributed data management system, and can remain unchanged when the file is touched (e.g., moved, changed, etc.) by a device on the network.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an example method for providing platform agnostic synchronization for a custom functionality attribute of a file in a distributed data management system.

FIG. 2 is a flow diagram illustrating one embodiment where one or more techniques described herein may be implemented.

FIG. 3 is a component diagram of an exemplary system for providing platform agnostic synchronization for a custom functionality attribute of a file in a distributed data management system.

FIG. 4 is a component diagram illustrating an example embodiment where one or more systems described herein may be implemented.

FIG. 5 is an illustration of an exemplary computer-readable medium comprising processor-executable instructions configured to embody one or more of the provisions set forth herein.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for synchronization of attributes associated with data across platforms. Further, a notion of attributes can be extended beyond a traditional file system attribute to comprise custom definitions of attributes for documents, folders, and/or other types of files. For example, one or more custom functionality attributes can be associated with files, folders, etc. where the attributes are platform and device agnostic, particularly in a distributed data management system, such as a mesh network of devices.

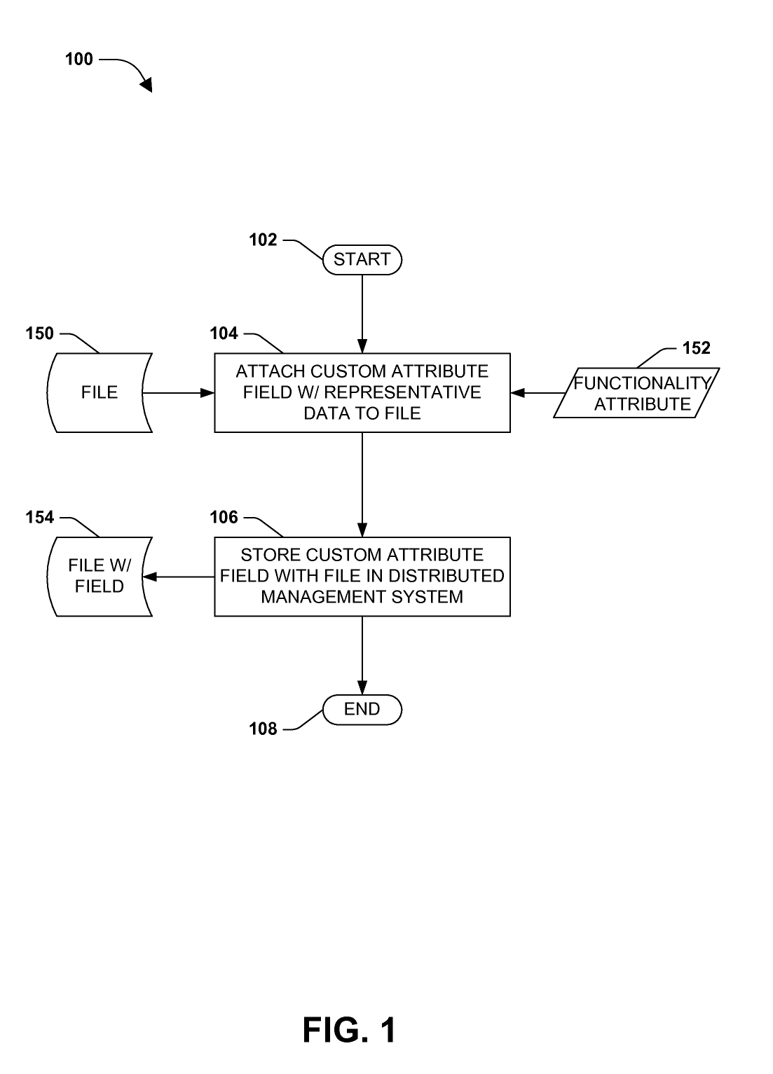

FIG. 1 is a flow diagram of an exemplary method 100 for providing platform agnostic synchronization for a custom functionality attribute of a file in a distributed data management system. The exemplary method 100 begins at 102 and involves attaching a custom attribute field to the file 150, such as a file in the distributed data management system, at 104, where the custom attribute field comprises data that is representative of the custom functionality attribute 152. It will appreciated that the term “file” is used broadly to represent any unit of data that may be stored in the distributed data management network, such as a document, folder, executable, library, system file, etc.

Distributed data management systems can comprise file synchronization platforms (e.g., mesh-type networks) that provide applications with an ability to replicate user data across devices of different form factors (e.g., mobile devices, PCs, laptops, storage devices, etc.), which may also be running different operating systems. As an example, a user may subscribe to a mesh network platform and configure their mobile device, home PC, work PC and portable laptop to synchronize their files across all of the devices. In this example, the respective devices connected to the mesh network platform can access a same version of a file, regardless of which device touched the file (e.g., moved, changed, viewed). In this example, the file is synchronized to the mesh network platform after being touched, and/or at some desired interval.

Further, for example, while the synchronization platforms can facilitate synchronization of data across platforms and between devices, some file attributes may not be able to be synchronized, and custom functionality attributes are not available for synchronization. A file attribute can provide information about how a file is treated in a file system hierarchy scheme. For example, a “hidden file” attribute provides for keeping the file hidden from view in a user interface (UI) comprising the file system in most situations. As another example, a “read-only” attribute merely allows the file to be opened and viewed. Other file attributes may also be associated with a file, such as “encrypted,” “compressed,” “archived,” “temporary,” and “system.” However, other than file specific attributes, such as name, size, time stamps, and endpoints, heretofore—without implementing at least some of at least one of the one or more systems and/or techniques provided herein, these additional attributes are not typically synchronized in a synchronization platform.

Additionally, custom functionality attributes may be created, for example, by creating a custom definition of a file attribute, and assigning it to some metadata property, such as the representation of the of the custom functionality attribute in the custom attribute field attached to the file. In one embodiment, an application resident on a device connected to the mesh network, for example, can manipulate the attributes for the file to apply custom, application specific behavior, which may be utilized mesh-wide. As an illustrative example, if a “hidden” file is edited on two endpoints relatively concurrently, thereby creating a conflict, an application may choose to resolve the conflict by “un-hiding” the conflicting files and copying both versions to a user's folder with different titles. In this example, this type of custom attribute can be created and applied to the custom attribute field attached to the file.

At 106 in the exemplary method 100, the custom attribute field is stored with the file 154 in the distributed data management system. For example, the mesh platform can store the custom functionality attribute in the custom attribute field as part of metadata that is related to the file, such as when the file is created and/or updated (e.g., edited, moved). In one embodiment, the custom attribute field can be stored as a bitmap field comprising the custom functionality attribute stored as a bit flag associated with the file. That is, for example, a value “2” (e.g., 0x00000002) can represent the file system “hidden” attribute, thereby comprising a bit-flag, where more than one attribute can be applied to the file. In this example, the bit-value “2” can be stored in the custom attribute field, which comprises metadata associated with, and stored with the file in the distributed data management system (e.g., mesh or cloud).

Having stored the custom attribute field with the file in the distributed data management system, the exemplary method 100 ends at 108.

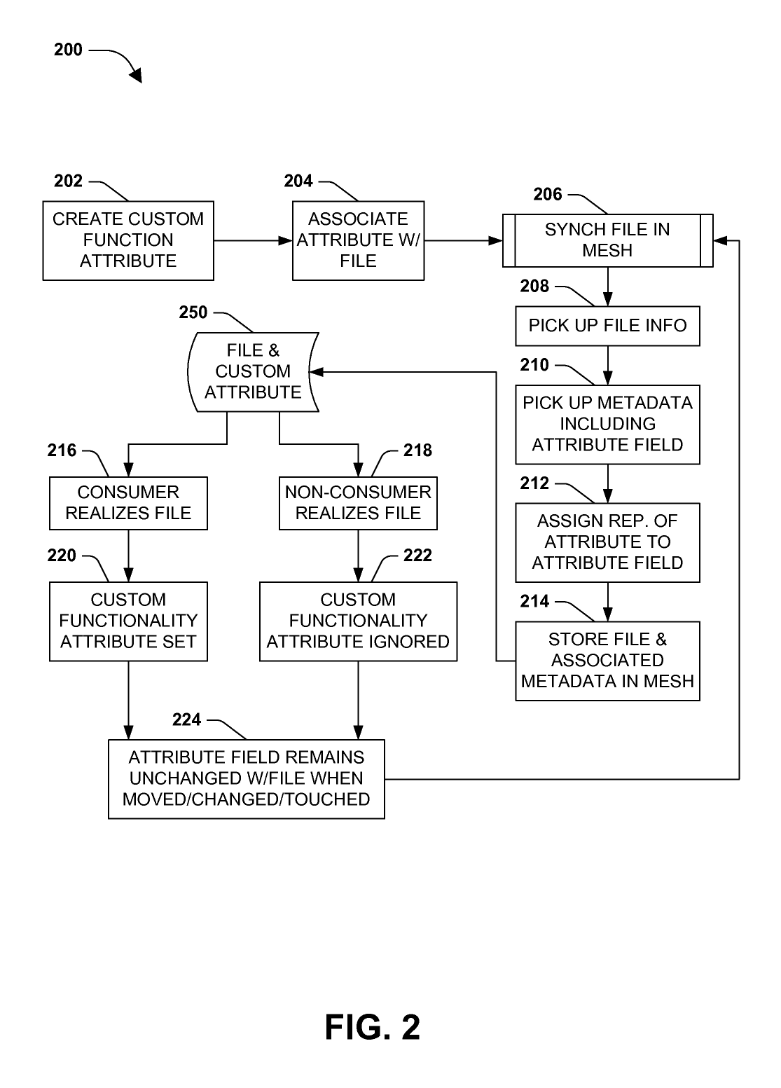

FIG. 2 is a flow diagram illustrating one embodiment 200 where one or more techniques described herein may be implemented. At 202, a custom function attribute is created, such as an application resident on the distributed data management system creating the custom functionality attribute for the file. For example, a media player application (e.g., that plays videos) may create a custom functionality attribute for media files where the attribute designates a playlist order for the media files (e.g., play the videos in a specified order). As another illustrative example, an application resident on the distributed data management system could create a custom function attribute that causes the file to be displayed in a desired manner, such as with a particular icon, or particular notification.

In one embodiment, the custom functionality attribute can comprise a file system attribute, such as an attribute that provides a particular way for the file to be handled when displayed in a file system UI on a connected device, as described above. As an example, a “hidden” attribute provides for the file to be hidden from view in the UI (e.g., often used for system files important to system operations that should not be changed or moved). In another embodiment, the custom functionality attribute can comprise an action associated with the file, such as a way the file is handled when realized on the device connected to the distributed data management system. As an example, the attribute may comprise ordering the file in a desired manner, displaying a desired icon, or requiring a particular user interaction with the file in order to open it.

In another embodiment, the custom functionality attribute can comprise a synchronization exclusion, and/or a synchronization inclusion functionality for the file. For example, a user of the mesh network and/or an application resident on a device connected to the mesh network may wish to exclude and/or include some files from being synchronized around the mesh, such as a type of black-list or white-list. In this example, the attribute may either prevent the file from being synchronized or ensure that the file is always synchronized.

At 204, the custom function attribute is associated with the file. For example, the custom function attribute can be created when the file is created and/or updated. When the file is created or updated, and the custom function attribute is created for the file, the attribute can be associated with the file, such as by the application and/or client device connected to the data management system. At 206, the file can be synchronized in the data management system, such as the mesh network. In one embodiment, when the file is created, updated, and/or moved, the file may be automatically synchronized in the mesh.

At 208, synchronizing the file in the mesh network can comprise picking up the file information. For example, when the file is created, updated, or moved the new information associated with the file is identified, such as by a synchronization application operable on the mesh. In one embodiment, the file can be stored in the mesh in a distributed manner, such as on one or more devices connected to the mesh. In this embodiment, the file can be represented in the mesh as an entry comprising information (e.g., metadata) that identifies the file, such as a name for the file, file location in the mesh, size, and/or type of file, among other things, which can be picked up for synchronization in the mesh.

Further, at 210, additional metadata for the file is picked up, which can comprise the custom functionality attribute associated with the file. As an example, the synchronization application resident in the mesh can pick up the information from the client device where the file was touched (e.g., created, updated, edited, moved, etc.). At 212, a representation for the custom functionality attribute (e.g., hidden, encrypted, read-only, or a custom functionality created for the file) can be assigned in the attribute field. In one embodiment, a bit value that is representative of the custom functionality attribute in a metadata file associated with the file can be assigned.

As an illustrative example, the custom attribute field can comprise a bit field where a bit value is assigned to represent the custom functionality. In this example, the bit value “2” can represent a “hidden” file attribute, and/or a bit value “4” may represent a “display icon” functionality for the file. Further, as an example, the metadata for the file picked up by the synchronization application may comprise:

<Title>name.txt</Title>
<LastUpdateTime>2010-11-11 3:14:15</LastUpdateTime>
<enclosure length=“217” attributes=“2x4”/>

At 214 in the example embodiment 200, the synchronization can comprise storing the file and/or the file information 250, comprising the metadata for the file including the custom attribute field, in the distributed data management system. As described above, a distributed data management system, such as a mesh-type network, can comprise stored data distributed over a plurality of devices connected to the network. In this way, for example, a storage load may not be biased to one particular device, and the data may be available to respective client devices connected to the network regardless of where the data is stored.

As an illustrative example, the metadata associated with the file can be bundled and stored on a connected device according to some load-balancing scheme utilized by the mesh. Further, the file associated with the metadata may be stored on a same device as the metadata, or can be stored on a different device, for example. In one embodiment, the file may remain stored on the device that created or updated the file, and the metadata can be stored on one or more of the connected devices (e.g., or on a central metadata storage device). In this embodiment, for example, the synchronization can comprise updating a location and associated metadata on the respective devices for the stored file, such that when a particular device wishes to access the data they can have the most recent metadata (e.g., including the custom functionality attribute information).

At 216 in the example embodiment 200, a consumer realizes the file. In one embodiment, the consumer can comprise a device that is connected to the distributed data management system, which is enabled to apply the custom functionality attribute. For example, the device may comprise settings and/or a configuration that allows it to understand the custom functionality attribute. In this example, the custom functionality attribute may merely be understood by a particular operating system, such that the device is able to read the custom attribute and apply it appropriately to the file when realized on the device (e.g., applying the “hidden file” attribute to a file or folder when displayed in a file hierarchy UI).

In another embodiment, the consumer can comprise an application that is resident on the distributed data management system, which is enabled to apply the custom functionality attribute. For example, the custom functionality attribute may comprise a mesh-wide functionality attribute, where the mesh network comprises an application that recognizes the custom attribute and can apply the functionality of the attribute on one or more of the client devices connected to the mesh. As an illustrative example, the “synchronization exclusion” or “synchronization inclusion” attribute may be applied by a synchronization application resident in the distributed data management system.

In one embodiment, the consumer of the data representative of the custom functionality attribute can define a behavior for the custom functionality attribute. As an example, when the consumer reads the custom functionality attribute, the consumer can apply the functionality for the file as defined by the consumer, such that a first consumer may apply the functionality as a first behavior for the file (e.g., keep conflicted files with the “hidden” attribute hidden) and a second consumer may apply the functionality as a second behavior for the file (e.g., un-hide conflicted files with the “hidden” attribute).

At 220, the custom functionality attribute can be set for the file when the file is realized on a device that is connected to the distribute data management system. For example, unless or until the file is actually realized by the device, such as by displaying the file or folder in a UI, the functionality is not applied to the file. In this embodiment, for example, the functionality can be defined and set for the file, such as hiding the file, displaying an icon, marking it as compressed, encrypted, or read-only, when realized in a storage hierarchy UI on the device.

At 218, a non-consumer realizes the file. In one embodiment, the non-consumer can comprise a device or application in the mesh that may not understand the custom functionality attribute, or may not be able to read the custom attribute field. As an example, the custom functionality attribute may be particular to an operating system or application (e.g., the creator of the custom functionality attribute), and therefore is not applied by the non-consumer. At 222, the non-consumer of the data representative of the custom functionality attribute can ignore the custom functionality attribute. As an example, while the non-consumer may not understand the attribute field, merely having it associated with the file should not affect the realizing of the file by the non-consumer.

At 224 in the example, embodiment 200, the custom attribute field can be kept with the file when the file is copied, changed or moved in the distributed data management system, and can remain unchanged. For example, unless the consumer changes the custom functionality attribute (e.g., changes the bit-flag, or removes the attribute) the attribute field can remain associated, such as in the metadata, with the file. That is, an overwrite or other type of operation may be performed, for example, such as where the consumer can understand, interpret, etc. what the custom functionality attribute represents, for example, otherwise the association can remain. Further, even when the non-consumer touches the file, the attribute field can remain unchanged and be propagated in any future synchronizations of the file on the mesh (e.g., at 206).

A system may be devised where one or more custom functionality attributes of a file can be synchronized on a distributed data management system, such as a mesh network or cloud-based data management network, for example. Further, the system may allow the custom functionality attributes to be platform and device agnostic, for example, where the mesh network may comprise a plurality of different types of devices that are running different operating systems. Additionally, the custom functionality attributes may not be merely limited to file storage hierarchy attributes, such as “hidden files,” for example, but may be extended to mesh-wide functionality attributes created and/or defined by applications and/or devices in the mesh.

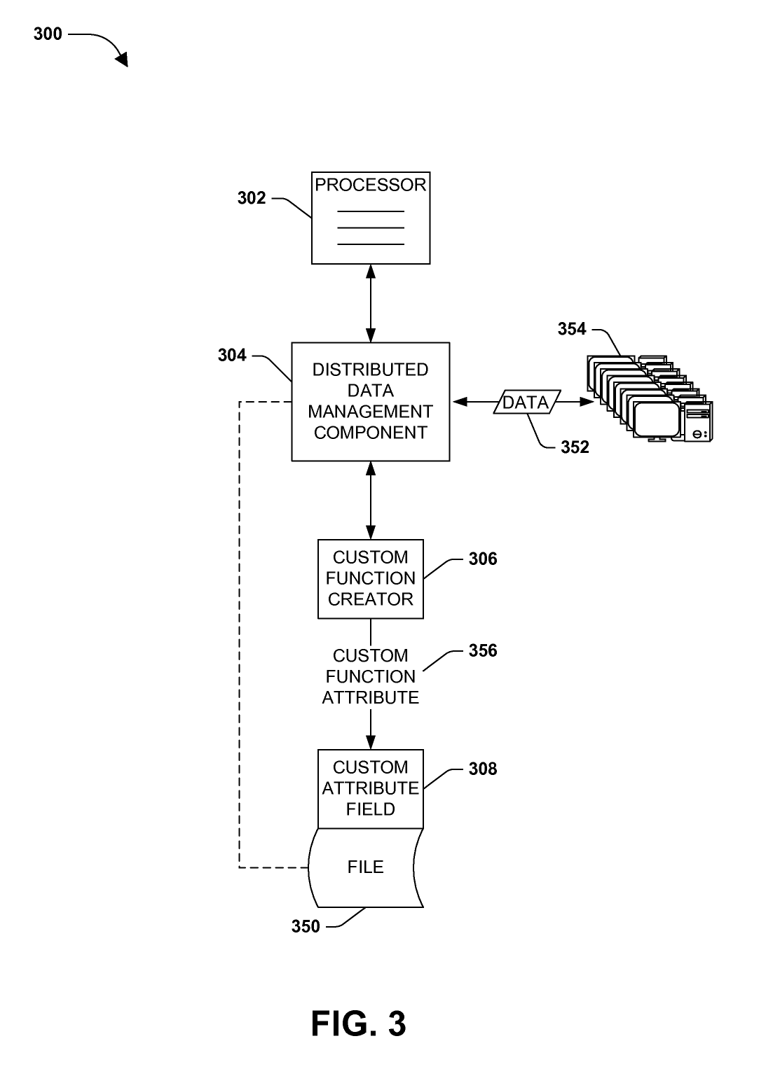

FIG. 3 is a component diagram of an exemplary system 300 for providing platform agnostic synchronization for a custom functionality attribute of a file in a distributed data management system. A processor 302 is configured to processing data for the system; and the processor 302 is operably coupled with a distributed data management component 304 that is configured to store data 352 distributed over a plurality of devices 354.

A custom functionality creation component 306 is operably coupled with the distributed data management component 304, and is configured to create a custom functionality attribute 356 for a file 350 resident on the distributed data management component 304. A platform agnostic custom attribute field 308 is attached to the file 350 on the distributed data management component 304; and the platform agnostic custom attribute field 308 stores a representation of the custom functionality attribute 356.

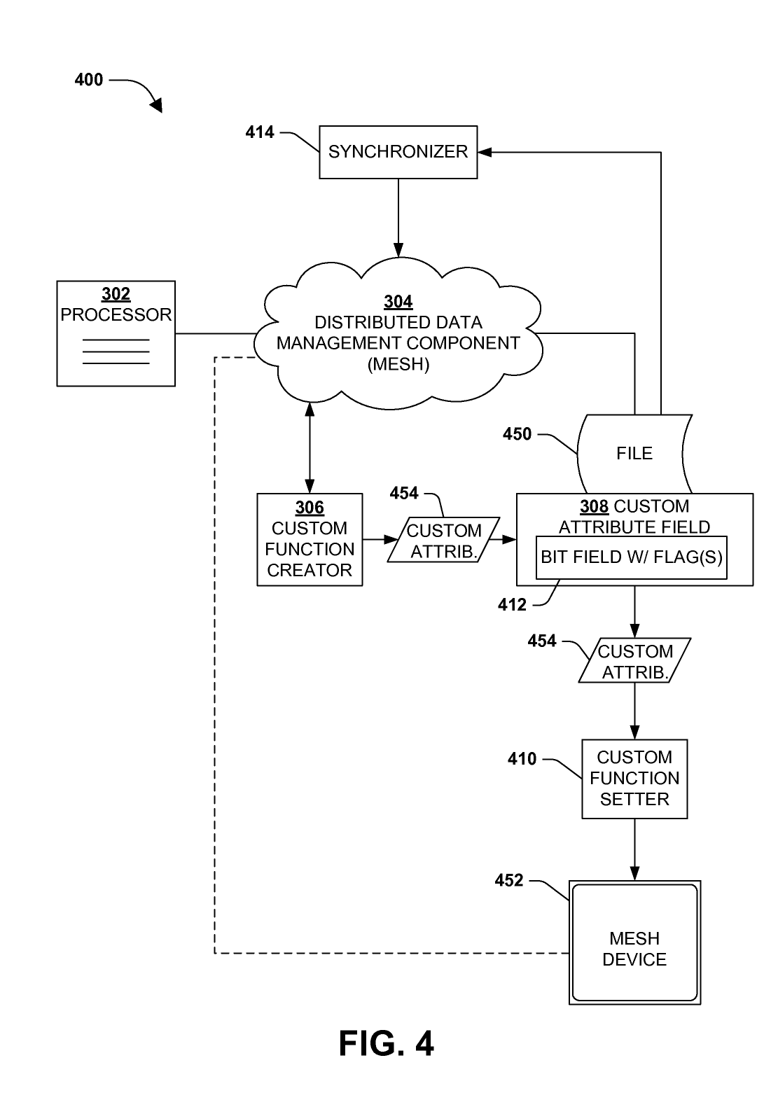

FIG. 4 is a component diagram illustrating an example embodiment 400 where one or more systems described herein may be implemented. A custom functionality setting component 410 can set a custom functionality attribute 454 when a file 450 is realized on a device 452 connected to the distributed data management component 304. In one embodiment, the distributed data management component 304 can comprise a mesh network that comprises a plurality of devices. For example, when a mesh device 452 opens a UI that handles file management, and the file is displayed in the UI, the functionality can be set by the custom functionality setting component 410, such as hiding the file for a “hidden” functionality, adding a particular icon for a custom functionality, or ignoring it if the device and/or the application realizing the file does not understand the custom attribute.

A synchronization component 414 can be configured to synchronize the file 450 between two or more devices in the distributed data management component 304, and synchronize the platform agnostic custom attribute field 308 attached to the file 450 between two or more devices in the distributed data management component 304. Further, in this embodiment, the representation of the custom functionality attribute can comprise a bit flag 412 in the platform agnostic custom attribute field 308. For example, the synchronization component 414 may automatically (e.g., programmatically) collect information for the file when the file is touched (e.g., moved, changed, updated, created, etc.) by a device and/or application in the mesh 304. In this example, the synchronization component 414 can synchronize both the file information (e.g., which may comprise file metadata) and the custom functionality attribute for the file (e.g., which can comprise a bit-flag, such as a bit value) throughout the mesh network 304.

In one embodiment, the platform agnostic custom attribute field 308 can remain unchanged when a non-consumer of the custom functionality attribute 454 interacts with the platform agnostic custom attribute field 308. For example, a non-consumer can comprise a device 452 and/or application that does not understand how to apply the custom attribute 454, or cannot read the attribute 454. In this example, the custom attribute 454 can merely be ignored by the non-consumer, and continue to be synchronized with the file around the mesh network 304.

In one embodiment, the custom functionality attribute 454 for a file 450 can comprise a distributed data management system-wide behavior for the file 450. For example, the custom functionality may describe how a file (e.g., a document, folder, executable, library, system file, or any representation of data in a file system hierarchy) behaves when realized by a consumer (e.g., application and/or device that understands the custom attribute) on the mesh network. As an illustrative example, when the file is realized the consumer may define the behavior by applying a particular behavior, such as opening the file in a particular order, applying a particular icon, displaying the file in a customized manner, or other functionalities.

In another embodiment, the custom functionality attribute 454 for a file 450 can comprise a file system attribute for the file 450 in the distributed data management system 304. For example, a consumer device may open a UI that displays stored and/or available files for the mesh. In this example, the file system hierarchy UI displays the files in a particular manner, depending on attributes for the files. For example, file folders may be shown to contain files, and other file folders. In this embodiment, the custom functionality attribute may be applied to the file system hierarchy, for example, where a file is hidden, encrypted, read-only, compressed; and the appropriate file system hierarchy can be applied using the custom functionality.

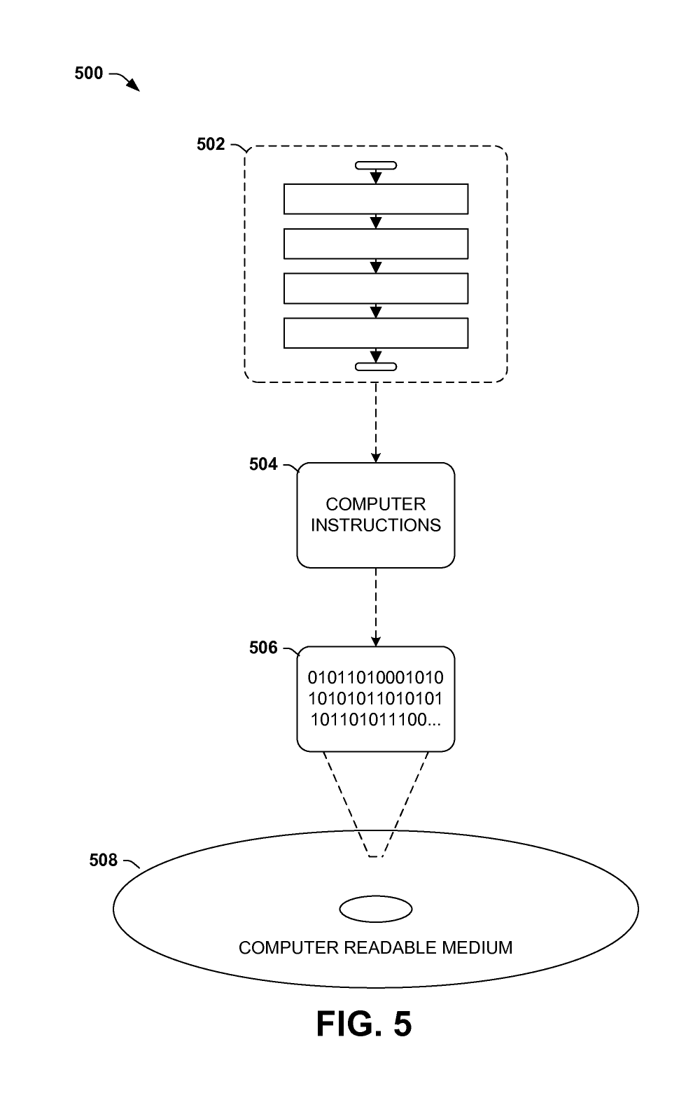

Still another embodiment involves a computer-readable medium comprising processor-executable instructions configured to implement one or more of the techniques presented herein. An exemplary computer-readable medium that may be devised in these ways is illustrated in FIG. 5, wherein the implementation 500 comprises a computer-readable medium 508 (e.g., a CD-R, DVD-R, or a platter of a hard disk drive), on which is encoded computer-readable data 506. This computer-readable data 506 in turn comprises a set of computer instructions 504 configured to operate according to one or more of the principles set forth herein. In one such embodiment 502, the processor-executable instructions 504 may be configured to perform a method, such as at least some of the exemplary method 100 of FIG. 1, for example. In another such embodiment, the processor-executable instructions 504 may be configured to implement a system, such as at least some of the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

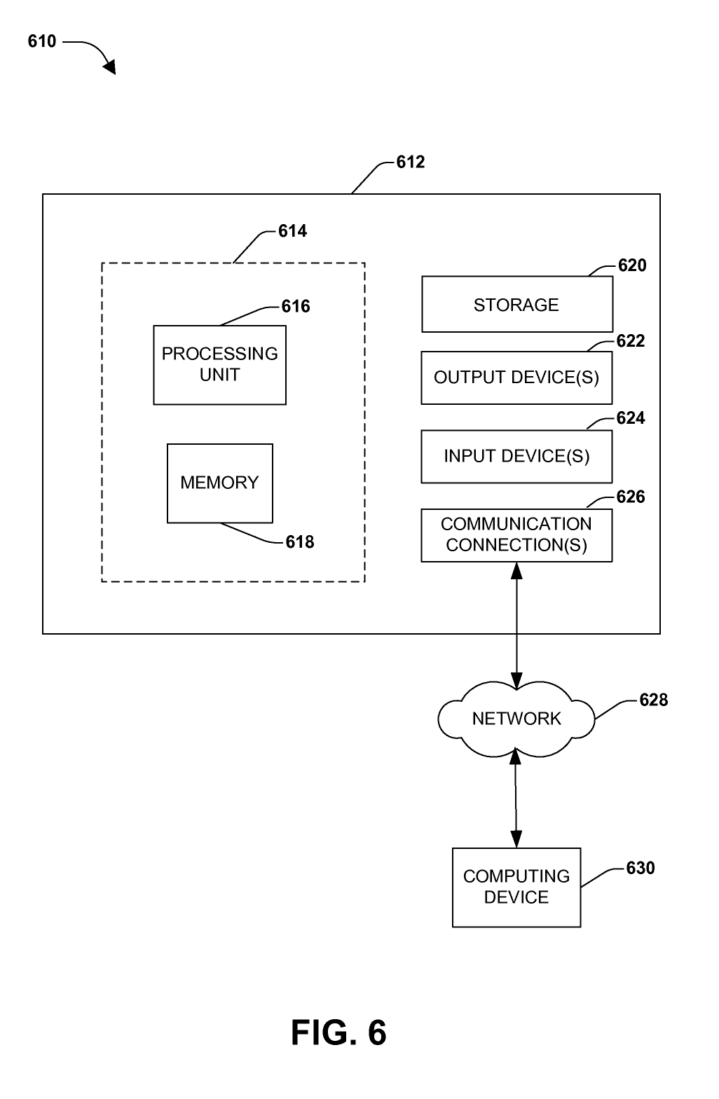

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 610 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for providing platform agnostic synchronization for a custom functionality attribute of a file in a distributed data management system, comprising:
attaching a custom attribute field to the file, using a computer-based processor, the custom attribute field comprising data representative of the custom functionality attribute; and
storing the custom attribute field with the file in the distributed data management system.

2. The method of claim 1, comprising setting the custom functionality attribute for the file when the file is realized on a device connected to the distributed data management system.

3. The method of claim 2, comprising setting the custom functionality attribute for the file when the file is realized in a storage hierarchy on a device connected to the distributed data management system.

4. The method of claim 1, comprising providing for a consumer of the data representative of the custom functionality attribute to define a behavior for the custom functionality attribute.

5. The method of claim 4, the consumer comprising a device connected to the distributed data management system that is configured to apply the custom functionality attribute.

6. The method of claim 4, the consumer comprising an application resident on the distributed data management system that is configured to apply the custom functionality attribute.

7. The method of claim 1, comprising providing for a non-consumer of the data representative of the custom functionality attribute to ignore the custom functionality attribute.

8. The method of claim 1, comprising keeping the custom attribute field with the file when the file is at least one of copied, changed, or moved in the distributed data management system.

9. The method of claim 1, the custom functionality attribute comprising one or more of:
a file system attribute;
an action associated with the file;
a synchronization exclusion; and
a synchronization inclusion.

10. The method of claim 1, storing the custom attribute field comprising storing the custom functionality attribute as a bit flag associated with the file.

11. The method of claim 1, comprising synchronizing the file in the distributed data management system, comprising assigning a bit that is representative of the custom functionality attribute in a metadata file associated with the file.

12. The method of claim 11, comprising an application resident on the distributed data management system creating the custom functionality attribute for the file.

13. A system for providing platform agnostic synchronization for a custom functionality attribute of a file in a distributed data management system, comprising:
a processor configured to process data for the system;
a distributed data management component operably coupled with the processor and configured to store data distributed over a plurality of devices;
a custom functionality creation component operably coupled with the distributed data management component, and configured to create a custom functionality attribute for a file resident on the distributed data management component; and
a platform agnostic custom attribute field attached to the file on the distributed data management component, and configured to store a representation of the custom functionality attribute.

14. The system of claim 12, comprising a custom functionality setting component configured to set the custom functionality attribute when the file is realized on a device connected to the distributed data management component.

15. The system of claim 12, the platform agnostic custom attribute field configured to remain unchanged when a non-consumer of the custom functionality attribute interacts with the platform agnostic custom attribute field.

16. The system of claim 12, the custom functionality attribute for a file comprising one or more of:
a distributed data management system-wide behavior for the file; and
a file system attribute for the file in the distributed data management system.

17. The system of claim 12, the distributed data management component comprising a mesh network comprising a plurality of devices.

18. The system of claim 12, the representation of the custom functionality attribute comprising a bit flag in the platform agnostic custom attribute field.

19. The system of claim 12, comprising a synchronization component configured to at least one of:
synchronize the file between two or more devices in the distributed data management component; and
synchronize the platform agnostic custom attribute field attached to the file between two or more devices in the distributed data management component.

20. A computer-based method for providing platform agnostic synchronization for a custom functionality attribute of a file in a distributed data management system, comprising:
an application resident on the distributed data managements system creating the custom functionality attribute for the file;
attaching a custom attribute field to the file, using a computer-based processor, the custom attribute field comprising data representative of the custom functionality attribute;
storing the custom attribute field with the file in the distributed data management system, comprising storing the custom functionality attribute as a bit flag associated with the file;
setting the custom functionality attribute for the file when the file is realized on a device connected to the distribute data management system, comprising:
providing for a consumer of the data representative of the custom functionality attribute to define a behavior for the custom functionality attribute; and
providing for a non-consumer of the data representative of the custom functionality attribute to ignore the custom functionality attribute; and
keeping the custom attribute field with the file when the file is copied or moved in the distributed data management system.
